(19) United States
(12) Patent Application Publication
(10) Pub. No.: US 2006/0108044 A1
(43) Pub. Date: May 25, 2006

(54) Apparatus for orienting and laminating binder-adhered wood chips and method of manufacturing wooden composite material

(76) Inventors: Koji Matsumoto, Kyoto-shi (JP); Takumi Murata, Kyoto-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/548,631

(22) PCT Filed: Aug. 11, 2003
(86) PCT No.: PCT/JP03/10197

§ 371 Date: Nov. 14, 2005

(30) Foreign Application Priority Data
Mar. 12, 2003 (JP) 2003-67053

(51) Int. Cl. B31B 1/60; B32B 37/00

(52) U.S. Cl. 156/60; 156/538; 156/349

(57) ABSTRACT

It is the object of the invention to provide an orienting and laminating apparatus of wood chips with a bonding agent applied which can produce continuously a long and thick wood composite material having mechanical strength enough to be used for a structural material, an orienting and laminating method of wood chips with a bonding agent applied, and a production method of a wood composite material. The invention relates to an orienting and laminating apparatus of a wood chip with a bonding agent applied, being an apparatus for orienting and laminating a wood chip with a bonding agent applied, which comprises a supply means of a wood chip with a bonding agent applied, an orientation means of the wood chip with a bonding agent applied, a means of vibrating the orientation means of the wood chip with a bonding agent applied, and a transportation means of a laminated mat of the wood chip with a bonding agent applied laminated, the orientation means of the wood chip with a bonding agent applied comprising a plurality of plates uprightly installed in parallel to be parallel to the transportation direction of the transportation means of the laminated mat, and the orientation means of the wood chip with a bonding agent applied being vibrated slantingly upward from the horizontal direction to the transportation direction of the transportation means of the laminated mat by the means of vibrating the orientation means of the wood chip with a bonding agent applied.

### FIELD OF THE INVENTION

The invention relates to an orienting and laminating apparatus of wood chips with a bonding agent applied which can produce continuously a long and thick wood composite material having mechanical strength enough to be used for a structural material, an orienting and laminating method of wood chips with a bonding agent applied, and a production method of a wood composite material.

### BACKGROUND ART

Among wood composite materials comprising wood chips bonded by a bonding agent are there materials having a mechanical strength so high as to be used as construction materials such as LSL (laminated strand lumber) and PSL (parallel strand lumber) and with respect to such a wood composite material, wood chips are oriented in the same direction as the fiber direction (the high strength direction of the anisotropic materials) of the wood chips to remarkably improve the mechanical strength in the fiber direction of the wood chips.

In the production of such a wood composite material, after the bonding agent is applied to the wood chips, a laminated mat comprising laminated wood chips bearing the bonding agent is produced. To make the wood composite material to be obtained have high mechanical strength, it is very important for the laminated mat that the wood chips of the laminated mat are sufficiently oriented in the fiber direction.

As the orienting and laminating apparatus of wood chips with a bonding agent applied, a variety of apparatuses for orienting wood chips principally by naturally dropping wood chips with a bonding agent applied and passing them through oriented plates have been devised. For example, an apparatus of orienting the wood chips by arranging a plurality of disks coaxially at prescribed intervals and rotating the disks and at the same time passing the wood chips with a bonding agent applied between the neighboring disks, or an apparatus of orienting the wood chips by arranging a plurality of plates in parallel and passing the wood chips between neighboring plates reciprocating in mutually opposed directions can be exemplified. However, these orienting and laminating apparatuses for the wood chips with a bonding agent applied have a problem that there are some wood chips among chips supplied by natural dropping are not sufficient oriented.

To deal with the problem, Japanese Kokai Publication Sho-59-48324 discloses a means of orienting shaved wood fragments by installing a substrate having side walls in both sides toward a transportation conveyer, which is installed under the supply position of the shaved wood fragments, at an optionally inclining angle, making the shape of the cross-section of a lower part concave-convex in the transverse direction at right angles to the inclining direction of the substrate, extending the concave-convex shape parallel to the inclining direction of the substrate, and vibrating the substrate. In this apparatus, the dropped shaved wood fragments are in non-oriented state in air immediately after dropping, and dispersedly dropped in the respectively concave parts of the concave-convex shape and vibrated by substrate vibration and therefore, in the initial stage, the shaved wood fragments are started receiving orienting force in the inclining direction of the substrate, that is the vibrating and transportation direction. In such a state, when the shaved wood fragments are dropped in the concave parts of the concave-convex shape, that is, a curved face in a corrugated form or the inclined face having a triangular shape in the state that the tip ends of the wood chips are not oriented, the shaved wood fragments receive action in the longitudinal direction of the shaved wood fragments and parallel to the faces of the concave parts owing to the vibration of the substrate and when the shaved wood fragments are vibrated and impacted against the convex parts, the shaved wood fragments longitudinally receive the moment of rotation in a direction at an acute angle to the impact angle as the reaction to the vibration, that is in the direction parallel to the convex parts. Accordingly, the shaved wood fragments which receive the moment of rotation are vibrated, transported and thus oriented longitudinally in the inclining direction of the substrate while being restricted by neighboring other shaved wood fragments.

The shaved wood fragments which dropped in the convex parts of the orientation means are well oriented by the apparatus disclosed in Japanese Kokai Publication Sho-59-48324, and successively other shaved wood fragments are dropped and laminated on the oriented shaved wood fragments and the shaved wood fragments laminated in the concave parts are downward moved along the inclination on the substrate owing to the vibration applied to the apparatus. However, the laminated shaved wood fragments contact with the substrate of the apparatus in the bottom faces and with the side walls of the concave parts of the apparatus in the side faces. Accordingly, to move the laminated shaved wood fragments, the shaved wood fragments require propelling force against the friction resistance which the bottom faces and side faces receive from the substrate and the side walls, however it is difficult to obtain the propelling force required for forwarding movement only by momentary jump of the laminated shaved wood fragments in air and it results in a problem that the lamination thickness cannot be thick. That is, although it is tried to laminate the shaved wood fragments thick in order to obtain a thick wood composite material from the shaved wood fragments, it is difficult and accordingly, it is difficult to obtain a thick wood composite material.

Japanese Kohyo Publication Hei-4-16046 discloses a wood chip platy body production method involving dropping a mixture containing thin and long wood fragments and a bonding agent through a plurality of slit plates arranged in parallel one another, successively depositing on a caul plate and then pressurizing and molding the wood fragments and in the production method, some desired slit plates are so arranged as to have intervals at a half or thinner than the average length of the thin and long wood fragments and on the other hand, other slit plates are so arranged as to have intervals equal to or longer than the average length of the thin and long wood fragments and the thin and long wood fragments are dropped between neighboring thin and long wood fragments to produce a wood chip platy body comprising oriented parts and non-oriented parts. In this production method, slit plates with different intervals are combined and lower end sides and the transportation top face are arranged at a gap so as to pass the thin and long wood fragments between the slit plates and form parts where the thin and long wood fragments are deposited with different orientation. With respect to the thin and long wood fragments oriented and laminated in the gap in the lower sides of the slit plates, friction is caused among the thin and long wood fragments one another or between the thin and long wood fragments and the slit plates and the friction force becomes higher as the thickness of the laminated layer of the thin and long wood fragments becomes thicker. Accordingly, when the thickness of the laminated layer reaches a certain thickness, the caul plate is moved to possibly result in breaking of the laminated product. To prevent such occurrence, the slit plates are reciprocated in the plate plane direction, that is, in the horizontal direction and thus the friction force is lowered and clogging between neighboring slit plates with the thin and long wood fragments is prevented.

In the production method described in Japanese Kohyo Publication Hei-4-16046, the orienting means is vibrated horizontally to prevent the blocking. However, if the vibrating direction is in the horizontal direction, although the laminated thin and long wood fragments are vibrated slightly in the horizontal direction, the thin and long wood fragments existing in the front and back directions of the vibrating of the thin and long wood fragments are moved insufficiently in the movement distance by the vibrating and in the case the thin and long wood fragments are laminated to a certain thickness, they are clogging owing to the friction with the plates and the laminated mat to be obtained is broken and in such a manner there is a problem of difficulty to make the lamination thickness thick. Also, there is a gap between the lower end side of the slit plates and the top face of the transportation means and the thin and long wood fragments are laminated after orientation, so that the orientation is disordered by the vibrating of the slit plates.

Further, Japanese Kokai Publication Hei-10-34615 discloses thin wood fragments orientation means of orienting thin wood fragments by passing them between orientation blades installed at prescribed pitches in an orientation apparatus and an orientation assisting tool comprising assisting blades arranged at prescribed pitches immediately under the orientation apparatus. This orientation apparatus comprises the assisting orientation blades set on a sending conveyer in a lower stage and orients the thin wood fragments by passing them through the orientation blades in an upper stage and at the same time preventing the clogging of the thin wood fragments between the orientation blades by vibrating the neighboring orientation blades up and down reciprocally and also again orienting and laminating the thin wood fragments whose orientation is disordered by the vibration by the assisting orientation blades in the lower stage. The reason for the vibration is the same as that of the invention disclosed in Japanese Kohyo Publication Hei-4-16046.

With respect to the apparatus disclosed in Japanese Kokai Publication Hei-10-34615, the thin wood fragments are oriented in passing them through the orientation blades in the upper stage and the thin wood fragments are oriented while the clogging of them is prevented by vibrating the neighboring orientation blades in the up and down direction and at the same time the thin wood fragments are laminated by dropping them on the sending conveyer. However, although the apparatus comprises the assisting orientation blades installed on the conveyer to laminate the thin wood fragments by dropping them thereon since the orientation of the thin wood fragments is disordered at the time of dropping, the assisting orientation blades are not vibrated and accordingly, there is a problem that when the laminated layer is thickened, the laminated product is broken. Additionally, if the orientation blades in the upper stage are vibrated in the up and down direction, the relative positions of the vibrated thin wood fragments are not changed in the horizontal direction and therefore, they may possibly be left as being clogged.

### SUMMARY OF THE INVENTION

It is the object of the invention to provide an orienting and laminating apparatus of wood chips with a bonding agent applied which can produce continuously a long and thick wood composite material having mechanical strength enough to be used for a structural material, an orienting and laminating method of wood chips with a bonding agent applied, and a production method of a wood composite material.

The invention provides an orienting and laminating apparatus of a wood chip with a bonding agent applied, being an apparatus for orienting and laminating a wood chip with a bonding agent applied, which comprises a supply means of a wood chip with a bonding agent applied, an orientation means of the wood chip with a bonding agent applied, a means of vibrating the orientation means of the wood chip with a bonding agent applied, and a transportation means of a laminated mat of the wood chip with a bonding agent applied laminated, the orientation means of the wood chip with a bonding agent applied comprising a plurality of plates uprightly installed in parallel to be parallel to the transportation direction of the transportation means of the laminated mat, and the orientation means of the wood chip with a bonding agent applied being vibrated slantingly upward from the horizontal direction to the transportation direction of the transportation means of the laminated mat by the means of vibrating the orientation means of the wood chip with a bonding agent applied. The orientation means of the wood chip with a bonding agent applied is preferably vibrated at an elevation angle of 15° to 70° slantingly upward from the horizontal direction to the transportation direction of the transportation means of the laminated mat by the means of vibrating the orientation means of the wood chip with a bonding agent applied.

The invention provides an orienting and laminating apparatus of a wood chip with a bonding agent applied, which comprises a supply means of a wood chip with a bonding agent applied, an orientation means of the wood chip with a bonding agent applied, a means of vibrating the orientation means of the wood chip with a bonding agent applied, and a transportation means of a laminated mat of the wood chip with a bonding agent applied laminated, the orientation means of the wood chip with a bonding agent applied comprising a plurality of plates uprightly installed in parallel to be parallel to the transportation direction of the transportation means of the laminated mat, and the upper end sides of a plurality of the plates being slanted along the transportation direction.

It is preferable that a gap between the lower ends of a plurality of the plates in the orientation means of the wood chip with a bonding agent applied and the transportation means of the laminated mat of the wood chip with a bonding agent applied laminated is made gradually wider toward the transportation direction of the transportation means.

The invention also provides an orienting and laminating method of a wood chip with a bonding agent applied, which comprises employing the orienting and laminating apparatus of the wood chip with a bonding agent applied of the invention.

The invention also provides a production method of a wood composite material, which comprises the steps of obtaining a wood chip from a raw material; classifying the wood chip in accordance with the length and thickness; adjusting a water content of the classified wood chip; applying a bonding agent to a surface of the wood chip with the adjusted water content; obtaining a laminated mat by orienting and laminating the wood chip with the bonding agent applied; and heating the laminated mat and pressurizing the laminated mat in the direction perpendicular to the longitudinal direction, the orienting and laminating apparatus of the wood chip with a bonding agent applied according to claim 1, 2, 3 or 4 being used in the step of obtaining a laminated mat by orienting and laminating the wood chip with the bonding agent applied.

It is preferable that the wood chip is compressed to have the cross-sectional area of 70% or lower in average of that of the raw material wood chip in the step of heating the laminated mat and pressurizing the laminated mat in the direction perpendicular to the longitudinal direction, and it is also preferable that heating is carried out in steam of 0.5 to 2 MPa in the step of heating the laminated mat and pressurizing the laminated mat in the direction perpendicular to the longitudinal direction.

The invention also provides a wood composite material, which is obtainable by using the production method of the wood composite material of the invention.

### BRIEF DESCRIPTION OF THE DRAWINGS

FIG. 1 is a perspective view of one example of an orienting and laminating apparatus of wood chips of the invention;

FIG. 2 is a side view showing one example of the distance between the lower ends of plates and a top face of transportation means;

FIG. 3 is a graph showing the relation between the vibrating elevation angle of the respective plate intervals and the height of the laminated layer of the wood chips;

FIG. 4 is a schematic view showing one example of the production method of a wood composite material of the invention;

FIG. 5 is a schematic view showing a cross-sectional view of the wood composite material;

FIG. 6 is a schematic view explaining the orientation of the wood chips in the wood composite material; and

FIG. 7 is a simplified perspective view of a conventional orientation means used in Comparative Example;

wherein, the following reference numerals and characters denote as follows: 1. an orienting and laminating apparatus; 2. a supply means; 3. an orientation means; 31, 32, . . . plates; 41, 42, . . . gaps; 5. a vibration-applying means; 51. a metal belt; 52. a vibrator; 53. a spring; 54. a supporting stand; 6. a transportation means; P. wood chips with a bonding agent applied; M. a laminated mat; K. a gap; 7b. wood chips; 7c. wood chips with a bonding agent applied; 8. a classifying apparatus; 9. a drying apparatus; 10. a drum blender; and 11. a bonding agent.

### DETAILED DESCRIPTION OF THE INVENTION

Hereinafter, the invention will be described in detail.

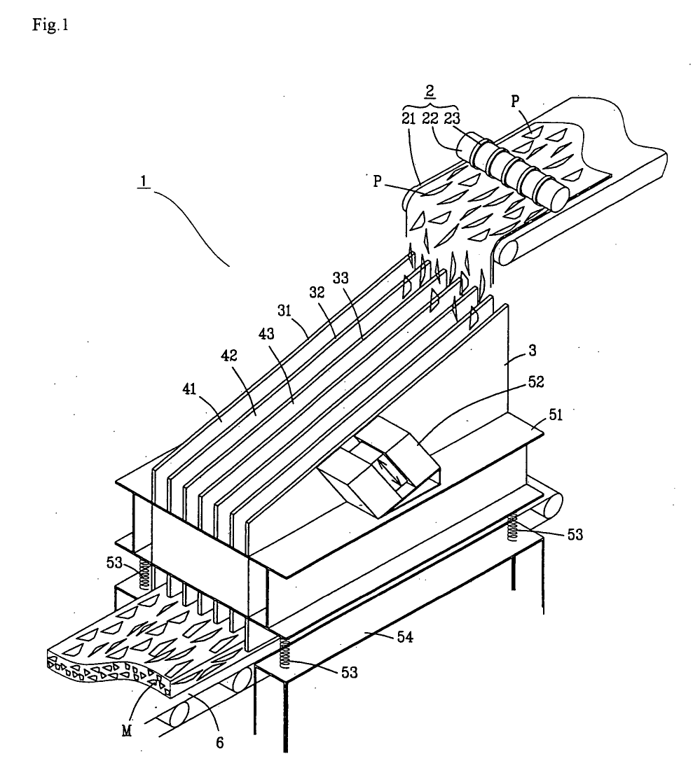

An orienting and laminating apparatus of wood chips with a bonding agent applied of the invention (hereinafter, simply referred as to an orienting and laminating apparatus in some cases) comprises a supply means of wood chips with a bonding agent applied (hereinafter, simply referred as to a supply means in some cases), an orientation means of the wood chips with a bonding agent applied (hereinafter, simply referred as to an orientation means in some cases), a means of vibrating the orientation means of the wood chips with a bonding agent applied (hereinafter, simply referred as to a vibration-applying means in some cases), and a transportation means of a laminated mat of the wood chips with a bonding agent applied (hereinafter, simply referred as to a transportation means in some cases). A schematic view showing one example of the orienting and laminating apparatus of the invention is illustrated in FIG. 1. The orienting and laminating apparatus of the invention illustrated in FIG. 1 comprises the supply means 1, the orientation means 3, and the transportation means 6 and also the vibration-applying means 5 connected to the orientation means 3. Hereinafter, the orienting and laminating apparatus of wood chips with a bonding agent applied of the invention will be described with reference to FIG. 1.

The supply means is not particularly limited if it can supply the wood chips with a bonding agent applied at a constant speed to the orientation means and for example, a belt conveyer, a roller conveyer and the like can be exemplified. In the example shown in FIG. 1, the supply means 2 is provided with a belt conveyer 21 and a leveling roller 22 having a plurality of ring-like convex stripes 23 parallel to each other in the surface.

The orientation means comprises a plurality of plates uprightly installed in parallel so as to be parallel to the transportation direction of the transportation means. The plates are not particularly limited and those made of a metal can be exemplified.

In the orientation means, it is preferable that the gaps between respectively neighboring plates among a plurality of the plates uprightly installed in parallel are equal. In the case the gaps between the respectively neighboring plates are equal, the orientation degrees of the wood chips with a bonding agent applied to be oriented while being passed between the respectively neighboring plates become almost equal and the quality of a laminated mat to be obtained becomes scarcely uneven. The gaps between the respective neighboring plates may be separated properly depending on the thickness of the wood chips to be oriented. For example, if the thickness of the wood chips with a bonding agent applied is 1 to 11 mm, the gaps are preferably 20 to 40 mm, and if the thickness of the wood chips with a bonding agent applied is 3 to 5 mm, they are preferably 20 to 30 mm.

The upper end sides of a plurality of the plates are slanted along the transportation direction. That is, the thin and long wood chips with a bonding agent applied striding over the plates are made easy to slide by vibrating the plates as described later and some are dropped to the gaps and others slide and move along the inclination. Accordingly, the wood chips do not prevent the wood chips with a bonding agent applied to be thrown later from smoothly dropping to the gaps and thus the wood chips with a bonding agent applied are more evenly and smoothly oriented and laminated on the transportation means. Consequently, the inclination is so installed as to prevent the dropped wood chips with a bonding agent applied from stagnating in same positions of the upper end sides of the plates and accordingly from collision against the wood chips with a bonding agent applied successively dropping later and from disturbance to the dropping of the latter wood chips. Vibration of the plates makes the wood chips striding over the upper end sides of the plates easy to slide and change the position. Accordingly, the inclination direction is preferably downward inclination toward the transportation direction, however it is sufficient if the wood chips can change the position and therefore, the inclination can be upward inclination toward the transportation direction.

It is preferable that a plurality of the plates are joined and united all together. Consequently, the entire body of the orientation means of the wood chips can be vibrated by connecting only single vibration means. A joining method is not particularly limited if the method does not disturb the dropping of the wood chips with a bonding agent applied in the gaps of the plates and for example, a method of joining the upper end parts in the upstream side or the upper end parts in the downstream side of the plates by welding with an iron plate and the like can be exemplified.

In the example shown in FIG. 1, the orientation means 3 comprises a plurality of plates 31, 32, . . . made of a metal and uprightly installed in parallel along the transportation direction of a wood mat by the transportation means 4 in a manner that gaps 41, 42, . . . are formed. A plurality of the plates 31, 32, . . . are joined in the end parts by welding a metal strip 51. Further, the upper end sides of the plates 31, 32, . . . are inclined to become gradually lower toward the transportation direction. A gap K is kept between the lower ends of the plates 31, 32, . . . and the top face of the transportation means 6. As shown in FIG. 2, the gap K may be made gradually wider toward the transportation direction. Formation of such a gap K makes it easy to remove the wood chips by moving the transportation means even if some of the wood chips are clogged in the gap.

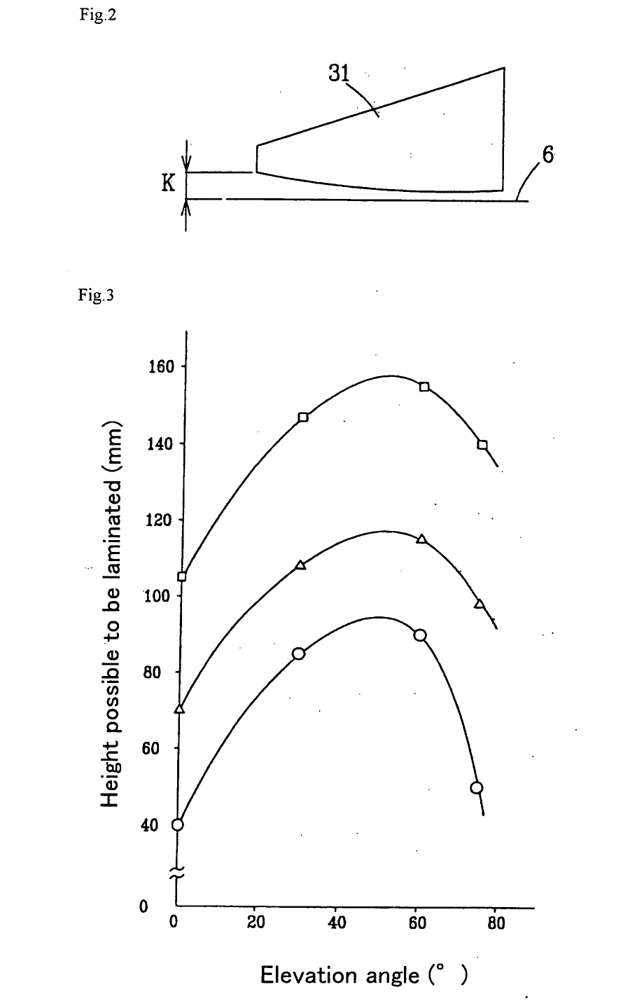

The vibration-applying means is not particularly limited and those whose amplitude, vibration frequency, or vibration direction is variable and whose vibration conditions are thus selective are preferable. The orientation means can be vibrated from the horizontal direction to the upward slanting direction in relation to the transportation direction of the laminated mat by the transportation means. Accordingly, even if the wood chips with a bonding agent applied and thrown to the gaps of the respectively neighboring plates of the orientation means are clogged between the plates by the friction force, since the plates are vibrated slantingly forward, the wood chips are sprung slantingly forward and moved in a relatively long movement direction, resulting in prevention of the wood chips from clogging between plates. The angle of the vibration is not particularly limited, and in the case the transportation speed of the laminated mat is 0.2 to 3 m/minute; the average value of the angles between the longer axial direction of the wood chips with a bonding agent applied in the laminated mat and the transportation direction of the laminated mat is 10 to 30°; and to obtain the laminated mat having a laminated layer height of 30 to 100 mm, the incidence angle toward the transportation direction of the wood mat is preferably 15° to 70°. If it is out of the range, when the laminated layer height is increased more, the wood chips with a bonding agent applied may possibly be clogged in the gaps between the neighboring plates. Further, the laminated layer height of the laminated mat can be adjusted by the angle of the vibration. The relation of the angle of the vibration and the laminated layer thickness of the laminated mat for respective gaps of plates is shown in FIG. 3. In the drawing, ◯ shows the case the gaps of the plates are 12 mm: Δ shows the case the gaps of the plates are 24 mm: and □ shows the case the gaps of the plates are 36 mm. In any case of these gaps of the plates, the laminated layer height of the laminated mat can be increased by adjusting the elevation angle of the vibration in a range of 15 to 70°.

The amplitude and the vibration frequency of the vibration may be proper if the wood chips with a bonding agent applied striding over the plates are dropped to the gaps and the dropped wood chips with a bonding agent applied which are oriented laminated on the transportation means do not slide or spring and their orientation is not disordered, and they may properly be selected in accordance with the quantity, the properties, and the size of the wood chips with a bonding agent applied to be supplied.

The installation position and installation methods of the vibration-applying means are not particularly limited if the wood chips with a bonding agent applied are not prevented from dropping in gaps between plates, and in the case a plurality of plates of the orientation means are joined by a metal plate and the like, it is preferable to install the means in the metal plate.

In the example shown in FIG. 1, the vibration-applying means 5 comprises the metal plate 51 formed in a manner of striding over two plates in both sides of the orientation means 3, a vibrator 52 and springs 53 supporting the entire body of the orienting and laminating apparatus 1 in the supporting part 54. In the case shown in FIG. 1, the springs 53 are installed in four corners of the orienting and laminating apparatus 1 and the number and supporting positions of the springs or the supporting method are not limited, if the apparatus can be vibrated stably, and any proper method may be designed corresponding to the situation based on the apparatus weight, size, and gravity center. Further, the vibrator 52 may be installed in any position of the orientation means 3, however no need to say, the gravity has to be well balanced so as not to generate abnormal vibration or residual vibration in the entire body of the orientation means 3. The vibration direction is preferably upward, slantingly up- and for-ward from the face of the belt conveyer 6 to the machine direction (MD) of the belt conveyer 6 or preferably in the. transverse direction (TD) of the belt conveyer 6. However, in the case the supply amount of wood chips with a bonding agent applied is small, even if the vibration is caused slantingly up- and back-ward, the wood chips P with a bonding agent applied and striding over the plates 31, 32, 33, . . . are dropped to the gaps 41, 42, . . . and therefore, it may properly be changed depending on the cases. Supporting springs for supporting the entire body of the vibrated orientation means 3, for example a plurality of supporting springs 54, are installed in the main part of the orientation means 3. Further, the entire body of the orientation means 3 may be hung by the springs.

The transportation means is not particularly limited and for example, a belt conveyer, a roller conveyer, and the like can be exemplified and the means may include a mounting means of the laminated mat such as a caul plate put on the belt conveyer or the roller conveyer. The caul plate means a metal plate with a prescribed size of a stainless steel, iron, or aluminum.

In the example shown in FIG. 1, the transportation means 6 comprises the belt conveyer and has the transportation direction parallel to the plates 31, 32, . . . .

Next, the method of orienting and laminating the wood chips with a bonding agent applied using the orienting and laminating apparatus of the invention will be described with reference to the apparatus shown in FIG. 1. The wood chips P with a bonding agent applied are put on the belt conveyer 21 of the supply means 2 and continuously supplied to the gaps 41, 42, . . . of the orientation means 3 while being leveled by the leveling roller 22 so as to have an approximately constant thickness. In the orientation means 3, the plates 31, 32, . . . of the orientation means 3 are vibrated by the vibration-applying means 5 and owing to the vibration, the wood chips P with a bonding agent applied striding over the plates are dropped to the gaps 41, 42, and laminated in a layer on the transportation means 6 while being oriented by the gaps 41, 42, . . . . The wood chips P with a bonding agent applied which are dropped while keeping the oriented state are received directly on the top face of the transportation means 6 or on the wood chips P with a bonding agent applied previously put on the transportation means 6 and thus successively laminated in a layer so as to be a laminated mat M with a prescribed thickness and at the same time the laminated mat M is transported toward a press apparatus, which is not illustrated, by the transportation means 6.

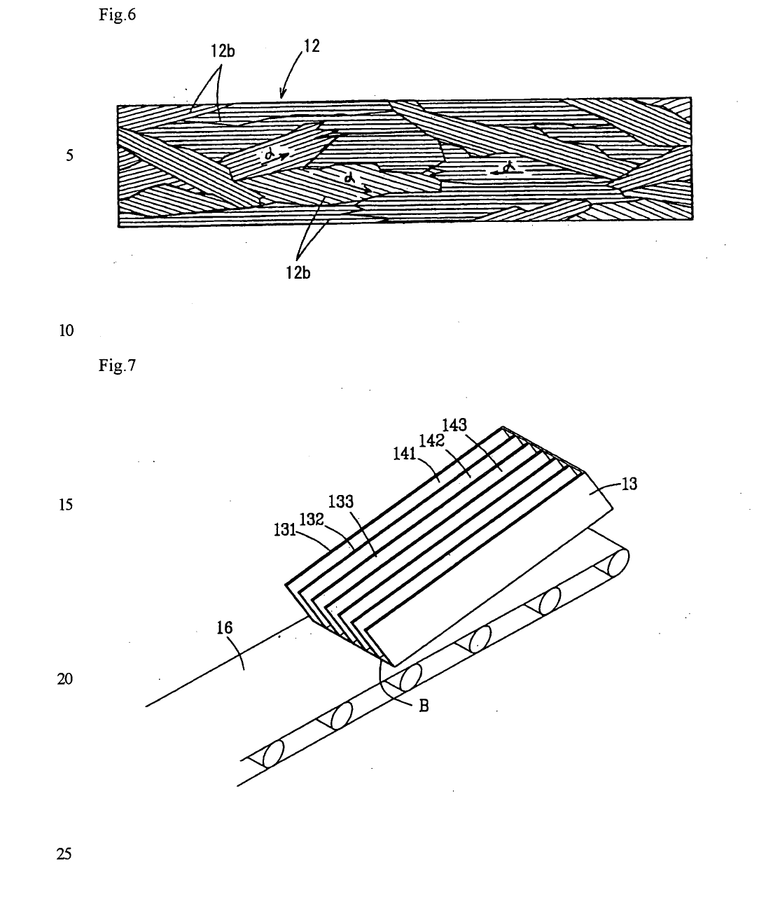

Use of the orienting and laminating apparatus of the wood chips with a bonding agent applied of the invention makes it possible to obtain the laminated mat comprising the wood chips remarkably excellently oriented and laminated in a layer, and consequently, a wood composite material having extremely high mechanical strength can be obtained. The orientation degree will be described with reference to FIG. 6. As shown in FIG. 6, the wood composite material 12 comprises thin and long wood chips 12b laminated in a manner that they are oriented in their longitudinal direction and bonded by the bonding agent. In this case, it is preferable that the absolute value of the angle α between the fiber direction of the respective wood chips 12b and the longitudinal direction of the wood composite material 12 is within 30° in average. If the absolute value exceeds 30°, it may possibly become impossible to obtain high enough mechanical strength to use the wood composite material usable as a structural material.

A method of measuring the orientation angle is not particularly limited and for example, the following methods may be employed for the measurement. At first, the images of wood chips of the wood composite material are photographed by a digital camera and taken in a computer. The image data is processed to extract the shapes from color values and luminance value by using an image processing soft such as “Paint Shop” (manufactured by JASK Software, ver. 6). Next, the images are subjected to cut-out treatment by Photo Shop (trade name: manufactured by Adobe Systems Inc., ver. 5) and the orientation angles and the sizes are measured by a determination program (Ellipse Model Soft Ware, developed by the applicant own company). The same work is repeated several times to measure the statistic orientation angle distribution and size distribution.

Use of the orienting and laminating apparatus of the wood chips with a bonding agent applied of the invention makes it possible to obtain a thick laminated mat by orienting and laminating the wood chips with a bonding agent applied and to obtain continuously a long and thick wood composite material, since the apparatus comprises no bottom plate such as conventional orientation means. Further, the orientation means is vibrated and the wood chips with a bonding agent applied can smoothly be dropped without clogging such as bridging phenomenon between neighboring plates composing the orientation means.

The invention also provides an orienting and laminating method of the wood chips with a bonding agent applied using the orienting and laminating apparatus of the wood chips with a bonding agent applied of the invention.

The invention also provides a production method of the wood composite material, which comprises steps of obtaining wood chips from a raw material; classifying the wood chips in accordance with the length and thickness; adjusting the water content of the classified wood chips; applying a bonding agent to the surface of the wood chips with an adjusted water content; obtaining a laminated mat by orienting and laminating the wood chips bearing the bonding agent; and heating the laminated mat and pressurizing the mat in the direction perpendicular to the longitudinal direction, in the step of obtaining a laminated mat by orienting and laminating the wood chips bearing the bonding agent, the orienting and laminating apparatus of the wood chips with a bonding agent applied of the invention being used.

In the production method of the wood composite material of the invention, at first, the step of obtaining wood chips from a raw material is carried out. A crusher is not particularly limited and conventionally known ones can be employed. A method of obtaining wood chips from the raw material is not particularly limited and conventionally known methods such as a method of cutting veneer processed raw material into a split chopstick-like shape by a rotary cutter and making the raw material into sticks; a method of shaving a log by a rotary blade of a flaker machine to obtain strands; and a method of crushing wood by rotating a roll having blades on the surface of a uniaxial crusher can be employed. Further a chip producing apparatus comprising cutting and shaving elements used generally for particle boards is also usable. Among them, since the wood chips produced by the crusher tend to have a spindle shape and easily obtain high strength, the apparatus is preferable. The crusher in this description also includes machines generally so-called pulverizers. In the wood composite material of the invention, the wood chips may directly be obtained from the raw material or those which are already processed into wood chips may be bought.

In the production method of the wood composite material of the invention, the step of classifying the wood chips depending on the length and thickness is, then, carried out. Use of wood chips uniform in the classified length and thickness by such a classification step can suppress the unevenness of the properties of the wood composite material to be obtained. The classification method is not particularly limited and for example, a classification method using a wave roller type classifying apparatus can be exemplified. The length of the classified wood chips can be confirmed by the image measurement.

In this case, it is preferable to carry out the classification so as to adjust the length and the thickness of the wood chips in ranges of 20 to 150 mm and 1 to 11 mm, respectively. If the length is shorter than 20 mm, mechanical strength high enough to use the wood chips as a structural material may not be obtained in some cases, and if it exceeds 150 mm, the crossing points in the laminated layer of a single wood chip are increased at the time of lamination of the wood chips and it results in impossibility of sufficient compression. The length of the wood chips in this description means the length of the wood chips in the longitudinal direction. If the thickness is thinner than 1 mm, the component material pieces become so small as to need a large amount of a binding agent and mechanical strength high enough to use the wood chips as a structural material may not be obtained in some cases, and if it exceeds 11 mm, the number of the laminated layers of the wood chips in the thickness direction is lessened, so that the stress transmission cannot be carried out sufficiently and the stress tends to be converged easily upon the joining points of the wood chips, resulting in difficulty of obtaining mechanical strength high enough to use the wood chips as a structural material in some cases. The thickness of the wood chips in this description means the shorter size between the sizes of each wood chip in two axial directions at right angles to each other and also to the longitudinal direction of the wood chip.

Wood chips with the length of 150 mm or shorter and the thickness of 11 mm or thinner are easily obtained from wood wastes, which are problem in recent years. That is, wood wastes include mill ends generated in plants and residence construction work fields; waste pallets disposed after material transportation; and disassembled waste materials generated at the time of construction disassembly, and since they are generally mixed with foreign materials such as metals and at the time of producing the wood chips by crushing them, a crusher with a high power has to be employed so as not to damage the blades for shaving process. In the case of crushing dry wood wastes by such a crusher, the length of the wood chips to be obtained inevitably becomes as short as about 2 to 10 cm. Accordingly, the production method of the wood composite material of the invention which can produce the wood composite material excellent in the mechanical strength from the wood chips having the length and thickness is remarkably advantageous in terms of the advantageous utilization of such a resource.

In the production method of the wood composite material of the invention, next, the step of adjusting the water content in the classified wood chips is carried out. Adjustment of the water content can suppress the unevenness of the properties of the wood composite material of the invention to be obtained. In this case, it is preferable to adjust the water content of the wood chips to be 10% or lower. As the method of adjusting the water content, a method of leaving the wood chips for a prescribed period in a temperature-controlled oven can be exemplified. In this connection, if the wood chips are left at 50° C. in an oven for 24 hours, the water content can be adjusted approximately 5%.

In the production method of the wood composite material of the invention, a step of applying a bonding agent to the surface of the wood chips with an adjusted water content is carried out. A method of applying the bonding agent is not particularly limited and in the case the bonding agent is a liquid, a method of spraying the bonding agent to the wood chips and a method of stirring and mixing the wood chips and the bonding agent can be exemplified. And in the case the bonding agent is a powder, a method of evenly mixing the wood chips and the bonding agent can be exemplified.

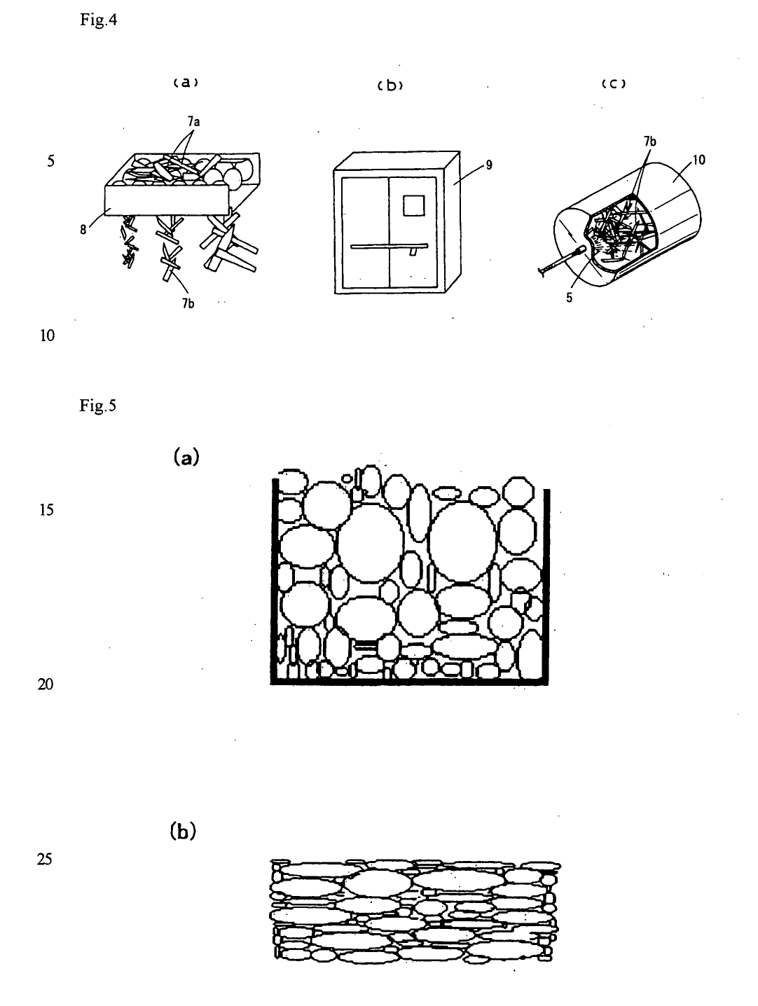

FIG. 4 is a schematic view showing one practical method of the wood composite material of the invention comprising steps of obtaining wood chips from a raw material; classifying the wood chips in accordance with the length and thickness; adjusting the water content of the classified wood chips; applying a bonding agent to the surface of the wood chips with the adjusted water content. In the production method of the wood composite material of the invention, as shown in FIG. 4(a), at first the wood chips 7a obtained by crushing a raw material such as wood wastes by a crusher are classified by a wave roller type classifying apparatus 8 to obtain wood chips 7b with the uniform length and thickness. Next, as shown in FIG. 4(b), the wood chips 7b are put in a dryer 9 to dry them to the water content 10% or lower and then, as shown in FIG. 4(c), the wood chips are thrown to a drum blender 10 and a bonding agent 11 is sprayed to the wood chips 7b in the drum blender 10 to make the wood chips 7b support the bonding agent 11 in the drum blander 10 and thus obtain the wood chips 7c bearing the bonding agent.

The wood chips bearing the bonding agent obtained in such a manner are oriented and laminated as described by using the orienting and laminating apparatus of the wood chips with a bonding agent applied of the invention to obtain a laminated mat.

In the production method of the wood composite material of the invention, the step of heating the obtained laminated mat and pressurizing the laminated mat in direction perpendicular to the longitudinal direction is carried out. A heating method is not particularly limited and for example, a method of transmitting heat to the inside by heat conduction from the surface of the laminated mat using a heat plate and a method of directly heating the inside by steam jetting or high frequency heating can be exemplified. The heating temperature is preferably 100 to 250° C. In the case of heating with steam, it is preferable to jet steam at a pressure of 0.5 to 2 MPa. If it is lower than 0.5 MPa, the laminated mat is not softened and therefore cannot be compressed in some cases and if it exceeds 2 MPa, the facility should be enlarged and therefore, it is not practical.

A pressurizing method is not particularly limited and for example, a method of using conventionally known vertical type pressing apparatus and continuously pressing apparatus for forming wood materials in the perpendicularly operating manner can be exemplified. The pressurizing condition is not particularly limited, however it is preferable to pressurize the laminated mat at 1 to 10 MPa pressure. If it is lower than 1 MPa, the compression cannot be carried out sufficiently and if it exceeds 10 MPa, the facility for pressurizing becomes expensive and it is not practical.

In the pressurization, it is preferable to compress the cross-sectional area of the wood chips to be 70% or lower in average of that of the wood chip raw material. Also in the pressurization, it is preferable to compress the wood chips in a manner that the specific gravity of the wood composite material to be obtained is 0.6 or higher. Further, it is also preferable to compress the wood chips in a manner that the porosity of the wood composite material to be obtained is 10% or lower. In the production method of the wood composite material of the invention, orientation and lamination of the wood chips is carried out by using the orienting and laminating apparatus of the wood chips with a bonding agent applied, so that such high compression is made possible. The wood composite material to be obtained is provided with extremely high mechanical strength by such high compression.

In the case of such high compression, with respect to the obtained wood composite material, the wood chips are observed to be flat in the compression direction when the wood composite material is observed in a cross-section perpendicular to the longitudinal direction of the wood composite material. FIG. 5 shows the cross-sectional view perpendicular to the longitudinal direction of the obtained wood composite material. FIG. 5(a) shows the state of the laminated mat put in a U-shaped guide before pressurization; and FIG. 5(b) shows the molded wood composite material after pressurization. The laminated mat obtained simply by orienting and depositing wood chips in the longitudinal direction has voids among wood chips and low strength. However, the wood composite material obtained by laminating wood chips which are made flat in the direction perpendicular to the longitudinal direction by high compression has physically small voids among the wood chips and is thus provided with high strength.

The heating and pressurizing steps may be carried out simultaneously or heating may be carried out after pressurization or pressurization may be carried out after heating. The heating and pressurizing steps are carried out until the bonding agent is cured.

In the production method of the wood composite material of the invention, it is preferable to carry out annealing, shaving, or sanding to improve the size precision and surface property of the wood composite material to be obtained.

According to the production method of the wood composite material of the invention, since the orienting and laminating apparatus of the wood chips with a bonding agent applied of the invention is employed, the wood chips are well oriented and a thick laminated mat can continuously be obtained, and a wood composite material having the mechanical strength high enough to be used as a structural material can be produced by high compression of the laminated mat.

The invention also provides a wood composite material obtained by the production method of the wood composite material of the invention.

Tree types of the raw material of the wood chips to be supplied to the production method of the wood composite material of the invention are not particularly limited and for example, needle-leaved trees such as Japan cedar, Japanese cypress, spruce, fir, and radiata pine, and broad-leaved trees such as white birch, apitong, kamerere, sengon laut, and aspen can be exemplified, and in addition to the plant materials produced in woods, plant materials produced in places other than wood such as bamboo and kaoliang can be employed.

The form to be utilized as the raw materials of the wood chips is not particularly limited and logs of the trees, raw materials of the lumber from thinning, edge wood generated in plants and residence construction work fields, waste pallets disposed after material transportation and disassembled waste materials generated at the time of construction disassembly can be exemplified.

The bonding agent to be supplied to the production method of the wood composite material of the invention is not particularly limited and adhesives for wood industries to be used plywood and particle boards such as phenol resins, urea resins, and isocyanates can be used. These bonding agents may be used alone or two or more of them may be used in combination.

### BEST MODES FOR CARRYING OUT THE INVENTION

Hereinafter, the invention will be described more in detail by means of Examples. However, it is not intended that the invention be limited to these Examples.

### EXAMPLE 1

Chips for a board bought from a waste wood treatment entrepreneur were classified by a wave roller type classifying apparatus, Wave Roller Screen (manufactured by TAIHEI MACHINERY CORPORATION) to obtain wood chips with thickness of 1 mm to 11 mm and length 20 mm to 150 mm at length/thickness=10 or higher and specific gravity 0.3 to 0.6. The specific gravity of the wood chips was subjected to sampling investigation and the length was confirmed by image measurement.

The obtained wood chips were left in a heating oven at 50° C. for 24 hours to adjust the water content to be 5.2%.

The wood chips with the adjusted water content and an isocyanate type adhesive as a bonding agent were thrown to a drum blender to obtain wood chips with a bonding agent applied comprising the wood chips coated with 5% by weight of the isocyanate adhesive.

The obtained wood chips with a bonding agent applied were thrown to the end part in the upstream side of an orienting and laminating apparatus by free drop at 4 kg/minute speed from the supply means 2 installed in the upstream side of the orienting and laminating apparatus 1 shown in FIG. 1, and oriented and laminated to obtain a laminated mat with height of 120 mm.

With the orienting and laminating apparatus 1, stainless steel plates with length of 500 mm, height of 500 mm, and thickness of 1.2 mm were uprightly installed at 25 mm pitches in parallel and the lower ends of the plates were kept at 30 mm clearance from the bent conveyer face and the lower ends of only the plates in both sides were kept at 2 mm clearance from the belt conveyer face. The plate upper ends were made to have slanting faces at 10° toward the machine direction of the belt conveyer from the horizontal direction. A metal belt was turned around just like a belt around the entire body of the orienting and laminating apparatus 1 and the respective plates 31, 32, 33, . . . were welded with the metal belt 51 at the end parts in the MD direction of the belt conveyer 6 to unit the entire body together. A vibrator 52 (a vibration motor RV-24D, manufactured by Shinko Electric Co., Ltd.) was fixed in a side in the TD side of the belt conveyer 6 in a manner that the vibration direction was up- and for-ward at 25° slantingly from the horizon. Supporting springs 53 were installed at four corners of the metal belt 151 to support the entire body of the orienting and laminating apparatus 1 on the supporting stand 54. The vibration conditions were adjusted to the amplitude 2 mm, vibration frequency 1,710 times/minute, and transportation speed of the belt conveyer 1 m/minute.

The obtained laminated mat was thrown to a heat conduction type pressing apparatus (300 t press manufactured by Kawasaki Hydromechanics Corp.) and pressurized at a heating temperature of 180° C. and pressurizing power 30 kg/cm² for pressurizing duration 10 minutes so as to adjust the final height 30 mm while the pressing board being kept to obtain a wood composite material.

All of the six faces of the obtained wood composite material were cut to obtain a plate of the wood composite material.

The obtained plate was subjected to measurements of the specific gravity, flexural strength, and flexural modulus according to JIS Z 2101 to find that the specific gravity was 0.78; the flexural strength was 45 MPa, and the flexural modulus was 11 GPa. The cross-section of the formed sample was copied by a copying machine and the weight (A) of paper of the cross-sectional part was measured and the voids among the wood chips were cut out and the weight (B) was measured to calculate the porosity according to the following expression to find that the porosity was 5%:
Porosity (%)=B/A×100

### COMPARATIVE EXAMPLE 1

Wood chips with a bonding agent applied were oriented and laminated by a conventional orienting and laminating apparatus having a bottom plate as shown in FIG. 7.

In FIG. 7, the wood chip supply means, vibration-applying means, and laminated mat were omitted. The orienting and laminating apparatus had the same structure as that of the orientation means 3 of the orienting and laminating apparatus employed in Example 1, the bottom plate B was installed in the lower ends of the respective plates. Accordingly, with the orienting and laminating apparatus, the wood chips dropped on the upstream side of the apparatus were laminated on the bottom plate B made to have an inclined face and owing to the vibration of the apparatus, the wood chips were sent downward along the inclined face.

The wood chips with a bonding agent applied same as those of Example 1 were supplied at the same speed in the condition that the inclination of the bottom plate was adjusted to be 10°, the vibration conditions were adjusted to keep amplitude 0.8 mm and vibration frequency 3,600 times/minutes. However the wood chips were clogged in the orienting and laminating apparatus to result in failure of obtaining a laminated mat.

### COMPARATIVE EXAMPLE 2

A laminated mat was produced in the same manner as in Comparative Example 1, except that the amplitude was changed to be 1.2 mm and the vibration frequency 3,500 times/minutes. However, in order to prevent the clogging of the wood chips, the loading amount of the wood chips with a bonding agent applied had to be 1 kg/minute and the movement speed of the wood chips was increased in the orienting and laminating apparatus and some portions became thin in the thickness and thus the thickness of the obtained laminated mat was at highest about 60 mm. Further, at the time of putting the wood chips on the belt conveyer 6, the wood chips were successively mounted on the previously mounted wood chips and the orientation direction was found shifting from the horizontal direction to the perpendicular direction.

A wood composite material was obtained by heating and pressurizing the laminated mat while adjusting the final thickness of the material to be 15 mm in the same manner as Example 1 and the faces were all cut to obtain a plate of the wood composite material.

The specific gravity, porosity, flexural strength, and flexural modulus were measured for the obtained plate in the in same manner as Example 1 to find that the specific gravity was 0.78; porosity was 5%, flexural strength was 25 MPa, and flexural modulus 4 GPa.

### INDUSTRIAL APPLICABILITY

The invention can provide an orienting and laminating apparatus of wood chips with a bonding agent applied which can produce continuously a long and thick wood composite material having mechanical strength enough to be used for a structural material, an orienting and laminating method of wood chips with a bonding agent applied, and a production method of a wood composite material.

1. An orienting and laminating apparatus of a wood chip with a bonding agent applied, being an apparatus for orienting and laminating a wood chip with a bonding agent applied,
which comprises a supply means of a wood chip with a bonding agent applied, an orientation means of the wood chip with a bonding agent applied, a means of vibrating the orientation means of the wood chip with a bonding agent applied, and a transportation means of a laminated mat of the wood chip with a bonding agent applied laminated,
the orientation means of the wood chip with a bonding agent applied comprising a plurality of plates uprightly installed in parallel to be parallel to the transportation direction of the transportation means of the laminated mat, and
the orientation means of the wood chip with a bonding agent applied being vibrated slantingly upward from the horizontal direction to the transportation direction of the transportation means of the laminated mat by the means of vibrating the orientation means of the wood chip with a bonding agent applied.

2. The orienting and laminating apparatus of a wood chip with a bonding agent applied according to claim 1,
wherein the orientation means of the wood chip with a bonding agent applied is vibrated at an elevation angle of 15° to 70° slantingly upward from the horizontal direction to the transportation direction of the transportation means of the laminated mat by the means of vibrating the orientation means of the wood chip with a bonding agent applied.

3. An orienting and laminating apparatus of a wood chip with a bonding agent applied,
which comprises a supply means of a wood chip with a bonding agent applied, an orientation means of the wood chip with a bonding agent applied, a means of vibrating the orientation means of the wood chip with a bonding agent applied, and a transportation means of a laminated mat of the wood chip with a bonding agent applied laminated, the orientation means of the wood chip with a bonding agent applied comprising a plurality of plates uprightly installed in parallel to be parallel to the transportation direction of the transportation means of the laminated mat, and the upper end sides of a plurality of the plates being slanted along the transportation direction.

4. The orienting and laminating apparatus of a wood chip with a bonding agent applied according to claim 1,
wherein a gap between the lower ends of a plurality of the plates in the orientation means of the wood chip with a bonding agent applied and the transportation means of the laminated mat of the wood chip with a bonding agent applied laminated is made gradually wider toward the transportation direction of the transportation means.

5. An orienting and laminating method of a wood chip with a bonding agent applied,
which comprises employing the orienting and laminating apparatus of the wood chip with a bonding agent applied according to claim 1.

6. A production method of a wood composite material,
which comprises the steps of obtaining a wood chip from a raw material; classifying the wood chip in accordance with the length and thickness; adjusting a water content of the classified wood chip; applying a bonding agent to a surface of the wood chip with the adjusted water content; obtaining a laminated mat by orienting and laminating the wood chip with the bonding agent applied; and heating the laminated mat and pressurizing the laminated mat in the direction perpendicular to the longitudinal direction, the orienting and laminating apparatus of the wood chip with a bonding agent applied according to claim 1 being used in the step of obtaining a laminated mat by orienting and laminating the wood chip with the bonding agent applied.

7. The production method of the wood composite material according to claim 6,
wherein the wood chip is compressed to have the cross-sectional area of 70% or lower in average of that of the raw material wood chip in the step of heating the laminated mat and pressurizing the laminated mat in the direction perpendicular to the longitudinal direction.

8. The production method of the wood composite material according to claim 6,
wherein heating is carried out in steam of 0.5 to 2 MPa in the step of heating the laminated mat and pressurizing the laminated mat in the direction perpendicular to the longitudinal direction.

9. A wood composite material,
which is obtainable by using the production method of the wood composite material according to claim 6.

10. The orienting and laminating apparatus of a wood chip with a bonding agent applied according to claim 2,
wherein a gap between the lower ends of a plurality of the plates in the orientation means of the wood chip with a bonding agent applied and the transportation means of the laminated mat of the wood chip with a bonding agent applied laminated is made gradually wider toward the transportation direction of the transportation means.

11. The orienting and laminating apparatus of a wood chip with a bonding agent applied according to claim 3,
wherein a gap between the lower ends of a plurality of the plates in the orientation means of the wood chip with a bonding agent applied and the transportation means of the laminated mat of the wood chip with a bonding agent applied laminated is made gradually wider toward the transportation direction of the transportation means.

12. An orienting and laminating method of a wood chip with a bonding agent applied,
which comprises employing the orienting and laminating apparatus of the wood chip with a bonding agent applied according to claim 2.

13. An orienting and laminating method of a wood chip with a bonding agent applied,
which comprises employing the orienting and laminating apparatus of the wood chip with a bonding agent applied according to claim 3.

14. An orienting and laminating method of a wood chip with a bonding agent applied,
which comprises employing the orienting and laminating apparatus of the wood chip with a bonding agent applied according to claim 4.

15. A production method of a wood composite material,
which comprises the steps of obtaining a wood chip from a raw material; classifying the wood chip in accordance with the length and thickness; adjusting a water content of the classified wood chip; applying a bonding agent to a surface of the wood chip with the adjusted water content; obtaining a laminated mat by orienting and laminating the wood chip with the bonding agent applied; and heating the laminated mat and pressurizing the laminated mat in the direction perpendicular to the longitudinal direction, the orienting and laminating apparatus of the wood chip with a bonding agent applied according to claim 2 being used in the step of obtaining a laminated mat by orienting and laminating the wood chip with the bonding agent applied.

16. A production method of a wood composite material,
which comprises the steps of obtaining a wood chip from a raw material; classifying the wood chip in accordance with the length and thickness; adjusting a water content of the classified wood chip; applying a bonding agent to a surface of the wood chip with the adjusted water content; obtaining a laminated mat by orienting and laminating the wood chip with the bonding agent applied; and heating the laminated mat and pressurizing the laminated mat in the direction perpendicular to the longitudinal direction, the orienting and laminating apparatus of the wood chip with a bonding agent applied according to claim 3 being used in the step of obtaining a laminated mat by orienting and laminating the wood chip with the bonding agent applied.

17. A production method of a wood composite material,
which comprises the steps of obtaining a wood chip from a raw material; classifying the wood chip in accordance with the length and thickness; adjusting a water content of the classified wood chip; applying a bonding agent to a surface of the wood chip with the adjusted water content; obtaining a laminated mat by orienting and laminating the wood chip with the bonding agent applied; and heating the laminated mat and pressurizing the laminated mat in the direction perpendicular to the longitudinal direction, the orienting and laminating apparatus of the wood chip with a bonding agent applied according to claim 4 being used in the step of obtaining a laminated mat by orienting and laminating the wood chip with the bonding agent applied.

18. The production method of the wood composite material according to claim 7,
wherein heating is carried out in steam of 0.5 to 2 MPa in the step of heating the laminated mat and pressurizing the laminated mat in the direction perpendicular to the longitudinal direction.

19. A wood composite material,
which is obtainable by using the production method of the wood composite material according to claim 7.

20. A wood composite material,
which is obtainable by using the production method of the wood composite material according to claim 8.
